(19) United States
(12) Patent Application Publication
(10) Pub. No.: US 2009/0179919 A1
(43) Pub. Date: Jul. 16, 2009

(54) Methods and Systems for Masking Visual Content

(76) Inventor: James M. Lidestri, Hopewell Junction, NY (US)

Correspondence Address: FISH & RICHARDSON P.C., P.O BOX 1022, Minneapolis, MN, 55440-1022, US

(21) Appl. No.: 12/354,967

(22) Filed: Jan. 16, 2009

Related U.S. Application Data
(60) Provisional application No. 61/021,580, filed on Jan. 16, 2008.

(51) Int. Cl. G09G 5/00

(52) U.S. Cl. 345/647

(57) ABSTRACT

Implementations of a computer-implemented method of modifying visual content include selecting visual content to be modified from a plurality of visual content stored in digital memory, presenting the visual content in a software-based tool for modifying the visual content and identifying at least one feature within the visual content for cover-up. At least one blocking graphic is placed over the at least one feature within the visual content to provide modified visual content, and the modified visual content is stored.

### CROSS-REFERENCE TO RELATED APPLICATION

The present application claims priority to U.S. Prov. Pat. App. No. 61/021,580, filed on Jan. 16, 2008, under 35 U.S.C. §119(e). U.S. Prov. Pat. App. No. 61/021,580 is expressly incorporated herein by reference in its entirety for all purposes.

### TECHNICAL FIELD

The present disclosure relates to modifying visual content, and more particularly to computer-implemented methods, computer readable medium, and systems for masking selected features of visual content.

### BACKGROUND

The advent of the Internet has enabled the transfer of information and data to millions of users worldwide. The Internet has also enabled electronic commerce, or e-commerce, which includes the buying and selling of products and/or services over electronic systems such as the Internet, and other computer networks. The amount of electronic trade has rapidly grown over the last decade or so.

Products that are sold through e-commerce can include creative works that are provided in electronic form. Such creative works can include digital writings (e.g., books, papers, articles), images, photos and videos. Digital creative works can be advertised online through a seller website, for example, and can be electronically transferred to a buyer, upon purchase. The online presentation of creative works can present significant problems. In the case of images, photos and/or videos, the creative works can include sexually explicit content, offensive content, brand names, trademarks and/or personally identifiable information.

### SUMMARY

The present disclosure is directed to computer-implemented methods, computer readable medium, and systems for masking selected features of visual content. In some implementations, a computer-implemented method of modifying visual content includes selecting visual content to be modified from a plurality of visual content stored in digital memory, presenting the visual content in a software-based tool for modifying the visual content, and identifying at least one feature within the visual content for cover-up. At least one blocking graphic is placed over the at least one feature within the visual content to provide modified visual content, and the modified visual content is stored.

In some implementations, the method further includes presenting a palette of digital blocking graphics, and selecting the blocking graphic from the palette of digital blocking graphics. In some embodiments, at least one blocking graphic of the palette of digital blocking graphics can be uploaded to the web-based tool by a user.

In other implementations, the method further includes adjusting a characteristic of the at least one blocking graphic.

In still other implementations, the step of identifying includes automatically processing the visual content to mark at least one potential feature within the visual content for cover-up. In some embodiments, the method further includes selecting at least one feature category, wherein the at least one potential feature corresponds to the at least one feature category. In some embodiments, the method further includes providing a sensitivity setting, wherein the at least one potential feature is marked based on the sensitivity setting. Some such embodiments further comprise evaluating a feature of the visual content to provide a rating, comparing the rating to a threshold that is provided based on the sensitivity setting, and marking the feature as a potential feature for cover-up, if the rating is greater than the threshold. In some embodiments, the method further includes confirming that the at least one potential feature should be covered, prior to the placing of the at least one blocking graphic.

In some implementations, the method further includes processing a plurality of visual content to provide a corresponding plurality of modified visual content.

In some implementations, a computer readable medium is encoded with a computer program having instructions that, when executed, operate to cause a computer to perform operations including selecting visual content to be modified from a plurality of visual content digitally stored in computer memory, presenting the visual content in a web-based tool for modifying the visual content, identifying at least one feature within the visual content for cover-up based on a selected feature category, placing at least one blocking graphic over the at least one feature within the visual content to provide modified visual content, and storing the modified visual content.

In some implementations, a system includes a network, and a computer that communicates over the network, and that has a computer-readable medium. The computer readable medium is encoded with a computer program having instructions that, when executed, operate to cause the computer to perform operations including selecting visual content to be modified from a plurality of visual content digitally stored in computer memory, presenting the visual content in a web-based tool for modifying the visual content, identifying at least one feature within the visual content for cover-up based on a selected feature category, placing at least one blocking graphic over the at least one feature within the visual content to provide modified visual content, and storing the modified visual content.

The details of one or more implementations of the present disclosure are set forth in the accompanying drawings and the description below. Other features, objects, and advantages of the invention will be apparent from the description and drawings, and from the claims.

### DESCRIPTION OF DRAWINGS

FIG. 1 is functional block diagram of an exemplar computer network.

FIG. 2 is an illustration of an exemplar screen-shot in accordance with the present disclosure.

FIG. 3 is an illustration of a screen-shot showing an exemplar, manual cover-up routine in accordance with the present disclosure.

FIGS. 4A-4C are illustrations showing an exemplar, automatic cover-up routine in accordance with the present disclosure.

FIG. 5 is a flowchart illustrating exemplar steps executed in accordance with some implementations of the present disclosure.

### DETAILED DESCRIPTION

The present disclosure is directed to computer-implemented methods, computer readable medium, and systems that enable a publisher of digital visual content to mask, or block, specific areas or features of the content. Such visual content can include, but is not limited to, photos, videos, and graphic/visual art.

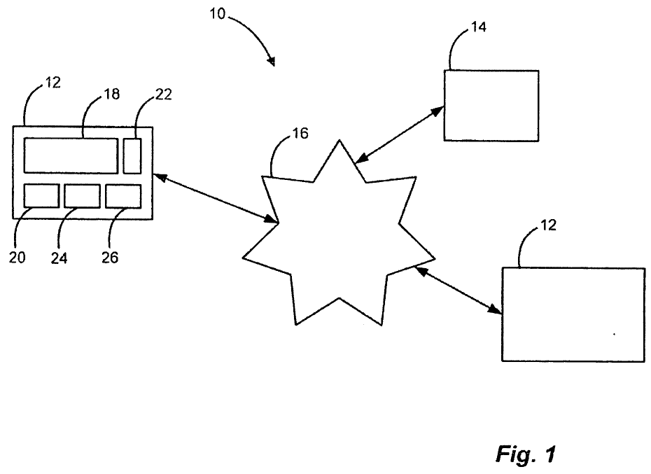

Referring now to FIG. 1, the various implementations of the processes of the present disclosure can be embodies in computer systems and computer programs. An exemplar computer network 10 includes a plurality of computers 12, and one or more servers 14 that communicate with one another over a network 16. The network 16 can include, but is not limited to, a local area network (LAN), a wide area network (WAN), and/or the Internet. An exemplar computer 12 includes a display 18, an input device 20, such as a keyboard and/or mouse, memory 22, a dataport 24, and a central processing unit (CPU) 26. The display 18 can include a CRT (cathode ray tube) or LCD (liquid crystal display) monitor for displaying information to the user. The input device 20 can include a keyboard, and/or a pointing device such as a mouse or a trackball, by which the user can provide input to the computer 12. Other kinds of devices can be used to provide for interaction with a user as well; for example, input from the user can be received in any form, including acoustic, speech, or tactile input.

A software program that executes one or more implementations of the present disclosure can be resident on one or more of the computers 12, and/or on the server 14. For example, the software program can be resident on a particular computer 12, which the user implements to process the content item(s), as described herein. Additionally, or in the alternative, the user can access a website through the network 16. In this case, the user performs the content item masking/blocking using the website.

Implementations of the processes of the present disclosure enable a user to select visual content, and place blocking graphics over selected areas or features within the content. As used herein, the user includes a publisher, distributor, or content provider of visual content. In general, the user includes a person, or persons, who make available, or otherwise distribute the visual content. The visual content is subsequently stored to the user's local system, LAN or posted to a website, which can be accessible through the network (e.g., Internet). Implementations of the present disclosure enable the user to easily and quickly cover an area of the content that the user does not wish to be seen by viewers. Exemplar applications include, but are not limited to, masking sexually explicit content, offensive content, brand names, trademarks and personally identifiable information that can include, but is not limited to, names, license plates, identification documents, faces, body parts, houses, cars, airplanes, boats, furniture, artwork, home furnishings, landmarks, and the like. It is contemplated that the content can be stored in multiple formats, including editable, modified content, uneditable, modified content, and the original, unmodified content.

The user may manipulate the visual content for ease of use in detecting selected areas and in placing blocking graphics over selected areas. These manipulations include enlarging and/or reducing the display size of the visual content and moving the display around different areas of the visual content (this is sometimes referred to as “pan and zoom”), and color adjustment (modify brightness, contrast, hue, saturation, correct gamma, histogram normalization and equalization).

Automatic detection of potential masking areas in the content can be provided. More specifically, suggestions can be generated and can be indicated using a shaded color, in a pattern or bounded by a border, for example. In short, the suggested areas are visually identified to the user within the visual content. The user can select a sensitivity setting for the automatic detection of masking patterns. For example, a highly selective setting results in more stringent criteria for blocking (i.e., fewer suggestions are generated), and a less selective setting results in less stringent criteria for blocking (i.e., more suggestions are generated). A scale of sensitivity settings can be provided, and the user can select the desired sensitivity setting from the array of sensitivity settings.

As one example, potential masking areas can be rated on a scale of likelihood. For example, the content can be automatically scanned and features of the content can be individually rated for the likelihood that the particular feature is one to be masked. If the rating exceeds a threshold that corresponds to the sensitivity setting, the particular feature is automatically masked. Using a human face as an example, a sensitivity setting can be provided, and the content can be automatically scanned to identify features that have the potential to be a human face. Each of the potential features can be assigned a rating that is automatically calculated based on a number of factors. Each rating is compared to a threshold corresponding to the sensitivity setting, and, if the rating exceeds the threshold, the particular feature is identified as a human face, in accordance with the present example.

For example, if a feature is rated at 80% for being a human face, and a sensitivity threshold is set at 90% (e.g., high sensitivity), that particular feature would not be identified as a human face. If another feature within the same content, however, is rated at greater than 90%, that particular feature would be identified as a human face. If, on the other hand, the sensitivity threshold was set at 50% (e.g., low sensitivity), both features of this example (i.e., the feature rated at 80%, and the feature rated at greater than 90%) would be identified as a human face. The identified feature(s) can be highlighted, and a user can confirm whether each particular feature that has been identified should be masked.

User selectable, and/or definable masking or blocking categories can be provided. More specifically, blocking categories are provided, from which the user selects a particular category or categories. Each blocking category can correspond to a category of potential features in the content to be masked or blocked. Exemplar blocking categories include, but are not limited to, sexually explicit content, offensive content, brand names, trademarks and personally identifiable information, which can include, but is not limited to, names, license plates, identification information, faces, body parts, houses, cars, airplanes, boats, furniture, artwork, home furnishings, landmarks, and the like. In the example described above, the category would correspond to ‘human face’.

For each blocking category, a specific algorithm is executed to identify the potential features to be masked, and suggestions are graphically displayed. Blocking category-specific blocking graphics can be selected by the user from pre-defined options, or custom category-specific blocking graphics can be provided by the user. More specifically, the user can select a blocking graphic from a number of pre-defined blocking graphics. The user can also use a custom blocking graphic that the user provides. The custom blocking graphics can be saved for future use by the user.

Features of the blocking graphic can be customizable. By way of non-limiting example, the user can select the size, the opacity (i.e., the level of transparency), the orientation (i.e., rotation), the shape (i.e., geometry), and/or pattern (e.g., color, pattern, boundary) for the blocking graphic. This feature selection can be made prior to the blocking graphic being applied on the content, or can be adjusted after the blocking graphic has been applied to the content. In short, the user can modify any one or all of the already placed blockings graphics, whether placed manually or automatically, by changing the pattern, size, opacity, orientation, shape, and/or position (i.e., dragging the blocking graphic to a new position). After the blocking graphics have been placed over features of the visual content, the user can selectively keep or delete any, or all of the already placed blocking graphics, whether placed manually or automatically.

The user can store the selected content location into a personal profile associated with the particular user. User credentials, such as usemame, passwords, and the like can also be stored for the content location to provide a secure content location. The user can load a previously stored content location from the user's personal profile. Further, the user can save the modified, or masked content to a previously stored content location from the user's personal profile.

Implementations of the present disclosure can also enable the user to load multiple content items, and to work on the multiple content items simultaneously. Furthermore, the user can save groups of stored settings, including one, or more of the blocking categories, the blocking graphics (e.g., pattern, size, orientation, shape, opacity, sensitivity). The user can select from the saved settings in subsequent content masking sessions. Consequently, the user is better able to process multiple content items according to the user's previously saved settings. Although some implementations enable the user to manually work on multiple items simultaneously, batch processing can also be provided. More specifically, the manual process provides multiple content items on a screen at the same time, where the user is working on the multiple content items together. A batch process is an automatic process that runs in the background according to stored user settings. For example, the batch processing can apply user-defined graphics, sensitivities, and the like to all of the content items in a particular location and can save them in a particular location with minimal user interference.

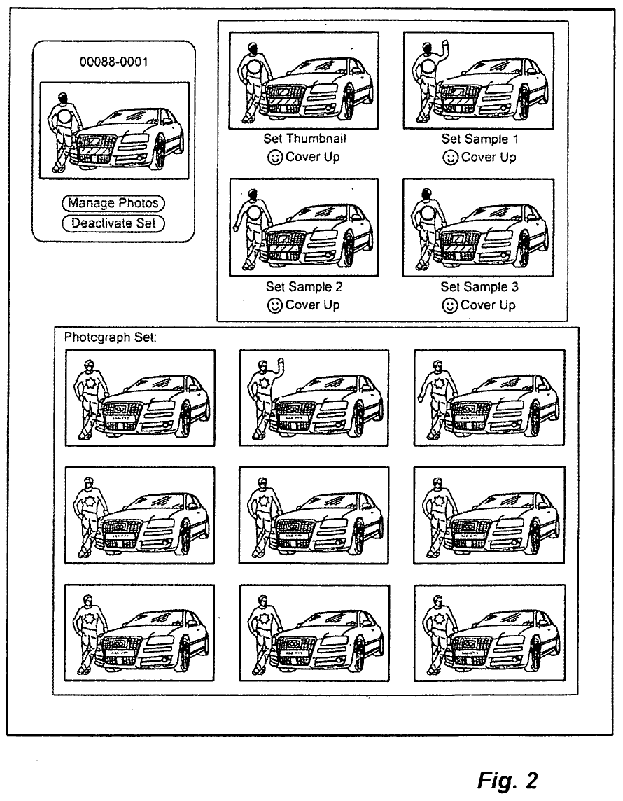

Referring now to FIG. 2, an illustration of an exemplar screen-shot in accordance with the present disclosure. The exemplar screen-shot includes a first pane that provides a thumbnail photo that is representative of a group, or set of photos, videos, or other visual content. In the present example, the set includes a set of photos. A second pane provides a sub-set that is representative of the set of photos, which sub-set includes cover-up graphics. A third pane provides the full set of photographs without cover-up graphics. As discussed in further detail herein, the cover-up graphics can be added manually or automatically. The exemplar screen-shot of FIG. 2 can include a private, user maintenance area of a website, for example, where a user can manage the content that he/she is making available for public viewing. Through the user maintenance area, a user can determine which photos of the set of photos to make available for initial public view, and can cover-up content within each of the photos of the sub-set of photos. A potential purchaser of the set of photos, for example, will only be able to view the sub-set of photos with cover-up, prior to purchasing the full set of photos.

To create the subset of photos, the user can select a photo from the set of photos and assign it as the thumbnail. Other photos can be selected from the set of photos, and can be assigned as sample photos (e.g., sample 1, sample 2 and sample 3). Prior to making the sub-set of photos available for public view, the user may desire, or in some cases may be required to cover-up certain content. For example, the user may desire, or be required to cover-up sexually explicit content, offensive content, brand names, trademarks and/or personally identifiable information. In the example of FIG. 2, the user can click the ‘cover-up’ button associated with a particular photo to initiate a cover-up process.

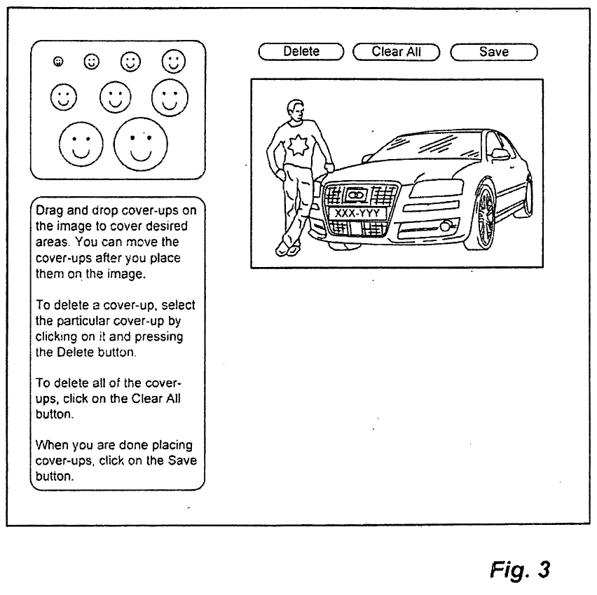

With reference to FIG. 3, an exemplar, manual cover-up process will be described. The exemplar screen-shot of FIG. 3 includes a graphics pane, an instruction pane, and the selected photo. It is appreciated that the graphics of the graphics pane are merely exemplary in nature and can include any graphics, including, but not limited to, graphics provided by the user. In the manual process, the user is able to click on and drag a blocking graphic from the graphics pane to the photo. The user can identify content for cover-up, and can place the graphic over the particular content. The user can delete a particular blocking graphic by clicking on the ‘delete’ button, can clear all of the placed blocking graphics by clicking on the ‘clear all’ button, and can save the modified (i.e., covered up) photo by clicking on the ‘save’ button. As discussed above, it is contemplated that the user can adjust the size, the opacity (i.e., the level of transparency), the orientation (i.e., rotation), the shape (i.e., geometry), and/or the pattern (e.g., color, pattern, boundary) of the blocking graphic. This feature selection can be made prior to the blocking graphic being applied on the content, or can be adjusted after the blocking graphic has been applied to the content.

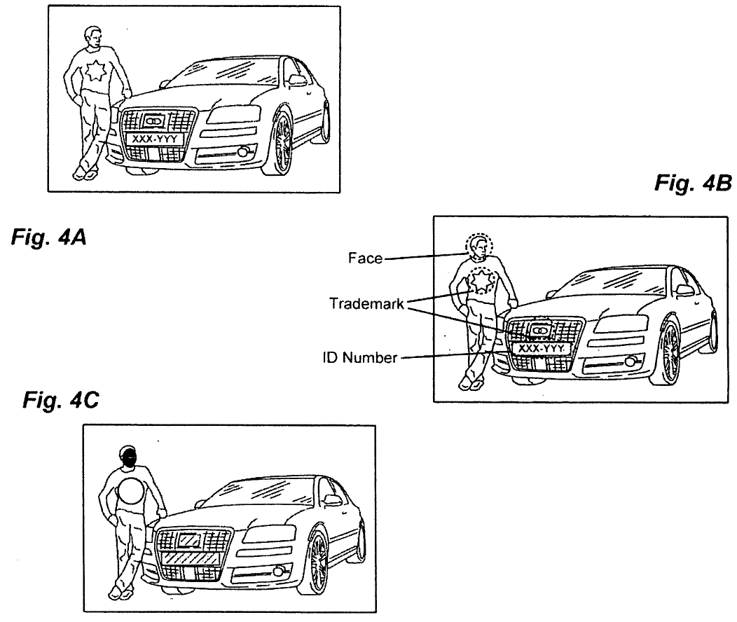

With reference to FIGS. 4A-4C, an exemplar, automatic cover-up process will be described. FIG. 4A illustrates a photo, for which cover-up is desired. Upon initiation by the user, the photo can be processed to identify features within the photo that may be ripe for cover-up. To achieve this, a sensitivity setting, and/or blocking categories can be implemented. In the example of FIGS. 4A-4C, exemplar blocking categories can include faces, trademark, brand names, and identification numbers. The categories, however, are not limited to those of the example of FIGS. 4A-4C. Upon processing of the photo, a face is identified, trademarks are identified, and an identification number is identified (see FIG. 4B). The identified content is highlighted to the user (e.g., circled), and the user can select which content should be covered up through application of a blocking graphic.

As seen in FIG. 4C, the blocking graphics are applied and can vary based on a user's choice. For example, the user can adjust the size, the opacity (i.e., the level of transparency), the orientation (i.e., rotation), the shape (i.e., geometry), and/or the pattern (e.g., color, pattern, boundary) of the blocking graphic. This feature selection can be made prior to the blocking graphic being applied on the content, or can be adjusted after the blocking graphic has been applied to the content. The example of FIG. 4C illustrates various, exemplar blocking graphic types. It is contemplated that the blocking graphics can be automatically placed after the user confirms what content is to be covered. In an alternative implementation, the user can manually place the blocking graphics after content for potential cover-up has been automatically identified.

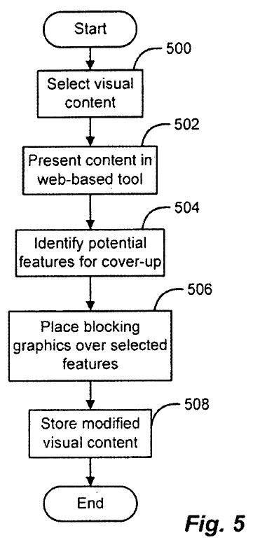

FIG. 5 is a flowchart illustrating excemplar steps that can be executed in accordance with some implementations of the present disclosure. In step 500, the user selects content (e.g., visual content) for cover-up. The content is content that is to be modified, and can be selected from a plurality of content digitally stored in computer memory. In step 502, the content is presented in a web-based tool that can be implemented for modifying the content. Feature(s) of the content for potential cover-up is/are identified in step 504. As discussed in detail above, this can be done manually by the user, or can be done automatically through processing of the content. In step 506, blocking graphics are placed over the selected features to provide modified content. Again, this can be achieved manually by the user, or can be done automatically after the user confirms which content is to be covered. Also, the user can adjust the size, the opacity (i.e., the level of transparency), the orientation (i.e., rotation), the shape (i.e., geometry), and/or the pattern (e.g., color, pattern, boundary) of the blocking graphic. This feature selection can be made prior to the blocking graphic being applied on the content, or can be adjusted after the blocking graphic has been applied to the content. In step 506, the modified visual content is stored to memory. It is appreciated that the steps of FIG. 5 are exemplar steps, and that the present disclosure can be implemented in processes including the same steps, more steps, or fewer steps.

The processes of the present disclosure can be implemented in digital electronic circuitry, or in computer hardware, firmware, software, or in combinations thereof. The invention can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Implementations of the present disclosure can be performed by one or more programmable processors executing a computer program to perform functions of the invention by operating on input data and generating output. Processes can also be performed by, and apparatus can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

Processes of the present disclosure can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network, a wide area network, and the Internet.

A number of implementations of the disclosure have been described. Nevertheless, it will be understood that various modifications may be made without departing from the spirit and scope of the disclosure. More specifically, implementations of the method and system of the present disclosure can include various combinations of the features described herein. For example, implementations of the method and system can include a plurality of the features described herein, while other implementations can include all of the features described herein.

What is claimed is:

1. A computer-implemented method of modifying visual content, comprising:
selecting visual content to be modified from a plurality of visual content stored in digital memory;
presenting the visual content in a software-based tool for modifying the visual content;
identifying at least one feature within the visual content for cover-up;
placing at least one blocking graphic over the at least one feature within the visual content to provide modified visual content; and
storing the modified visual content.

2. The method of claim 1, further comprising:
presenting a palette of digital blocking graphics; and
selecting the blocking graphic from the palette of digital blocking graphics.

3. The method of claim 2, wherein at least one blocking graphic of the palette of digital blocking graphics can be uploaded to the software-based tool by a user.

4. The method of claim 1, further comprising adjusting a characteristic of the at least one blocking graphic.

5. The method of claim 1, wherein the identifying includes automatically processing the visual content to mark at least one potential feature within the visual content for cover-up.

6. The method of claim 5, further comprising selecting at least one feature category, wherein the at least one potential feature corresponds to the at least one feature category.

7. The method of claim 5, further comprising providing a sensitivity setting, wherein the at least one potential feature is marked based on the sensitivity setting.

8. The method of claim 7, further comprising:
evaluating a feature of the visual content to provide a rating;
comparing the rating to a threshold that is provided based on the sensitivity setting; and
marking the feature as a potential feature for cover-up, if the rating is greater than the threshold.

9. The method of claim 5, further comprising confirming that the at least one potential feature should be covered, prior to the placing of the at least one blocking graphic.

10. The method of claim 1, further comprising processing a plurality of visual content to provide a corresponding plurality of modified visual content.

11. A computer-readable medium encoded with a computer program comprising instructions that, when executed, operate to cause a computer to perform operations comprising:
selecting visual content to be modified from a plurality of visual content stored in digital memory;
presenting the visual content in a software-based tool for modifying the visual content;
identifying at least one feature within the visual content for cover-up;
placing at least one blocking graphic over the at least one feature within the visual content to provide modified visual content; and
storing the modified visual content.

12. The computer-readable medium of claim 11, wherein the operations further comprise:
presenting a palette of digital blocking graphics; and
selecting the blocking graphic from the palette of digital blocking graphics.

13. The computer-readable medium of claim 12, wherein at least one blocking graphic of the palette of digital blocking graphics can be uploaded to the software-based tool by a user.

14. The computer-readable medium of claim 11, further comprising adjusting a characteristic of the at least one blocking graphic based on user input.

15. 1he computer-readable medium of claim 11, wherein the identifying includes automatically processing the visual content to mark at least one potential feature within the visual content for cover-up.

16. The computer-readable medium of claim 15, wherein the operations further comprise selecting at least one feature category based on user input, wherein the at least one potential feature corresponds to the at least one feature category.

17. The computer-readable medium of claim 15, wherein the operations further comprise providing a sensitivity setting, wherein the at least one potential feature is marked based on the sensitivity setting.

18. The computer-readable medium of claim 17, wherein the operations further comprise:
evaluating a feature of the visual content to provide a rating;
comparing the rating to a threshold that is provided based on the sensitivity setting; and
marking the feature as a potential feature for cover-up, if the rating is greater than the threshold.

19. The computer-readable medium of claim 15, wherein the operations further comprise confirming that the at least one potential feature should be covered based on user input, prior to the placing of the at least one blocking graphic.

20. The computer-readable medium claim 11, wherein the operations further comprise processing a plurality of visual content to provide a corresponding plurality of modified visual content.

21. A system, comprising:
a network;
a computer that communicates over the network, and that has a computer-readable medium encoded with a computer program comprising instructions that, when executed, operate to cause a computer to perform operations comprising:
selecting visual content to be modified from a plurality of visual content stored in digital memory;
presenting the visual content in a web-based tool for modifying the visual content;
identifying at least one feature within the visual content for cover-up;
placing at least one blocking graphic over the at least one feature within the visual content to provide modified visual content; and
storing the modified visual content.

22. The system of claim 21, wherein the operations further comprise:
presenting a palette of digital blocking graphics; and
selecting the blocking graphic from the palette of digital blocking graphics.

23. The system of claim 22, wherein at least one blocking graphic of the palette of digital blocking graphics can be uploaded to the software-based tool by a user.

24. The system of claim 21, further comprising adjusting a characteristic of the at least one blocking graphic based on user input.

25. The system of claim 21, wherein the identifying includes automatically processing the visual content to mark at least one potential feature within the visual content for cover-up.

26. The system of claim 25, wherein the operations further comprise selecting at least one feature category based on user input, wherein the at least one potential feature corresponds to the at least one feature category.

27. The system of claim 25, wherein the operations further comprise providing a sensitivity setting, wherein the at least one potential feature is marked based on the sensitivity setting.

28. The system of claim 27, wherein the operations further comprise:
evaluating a feature of the visual content to provide a rating;
comparing the rating to a threshold that is provided based on the sensitivity setting; and
marking the feature as a potential feature for cover-up, if the rating is greater than the threshold.

29. The system of claim 25, wherein the operations further comprise confirming that the at least one potential feature should be covered based on user input, prior to the placing of the at least one blocking graphic.

30. The system of claim 21, wherein the operations further comprise processing a plurality of visual content to provide a corresponding plurality of modified visual content.
